(19) United States
(12) Patent Application Publication
(10) Pub. No.: US 2005/0126055 A1
(43) Pub. Date: Jun. 16, 2005

(54) Crawler type traveling apparatus

(76) Inventors: Karl R. Dommert, Chattanooga, TN (US); James Franks, Ringgold, GA (US)

Correspondence Address: VARNDELL & VARNDELL, PLLC, 106-A S. COLUMBUS ST., ALEXANDRIA, VA, 22314, US

(21) Appl. No.: 10/714,933

(22) Filed: Nov. 18, 2003

(51) Int. Cl. G05D 1/02

(52) U.S. Cl. 37/348

(57) ABSTRACT

In a crawler type traveling apparatus so arranged on each side of a vehicle as to be capable of rocking up and down through each pivot shaft and including a track frame rocking round the pivot shaft, and a final reduction gear inclusive of a sprocket and a hydraulic motor that are provided at an end part of the track frame, the invention provides a crawler type traveling apparatus for achieving a compact and economical piping construction and high reliability. A hydraulic motor is provided on a vehicle inner side with respect to a final reduction gear. Hydraulic passages communicating with the hydraulic motor are formed in a pivot shaft. Ports for connecting respectively a predetermined number of hydraulic piping arrangements connected to the hydraulic motor and the like are formed in an outer peripheral surface of the pivot shaft.

### BACKGROUND OF THE INVENTION

1. Field of the Invention

This invention relates to a crawler type traveling apparatus.

2. Description of the Related Art

Vehicles such as bulldozers, excavators, crawler cranes and the like include crawler type traveling apparatuses arranged on the right and left sides thereof.

In the excavators among them, a final reduction gear inclusive of a sprocket and an hydraulic motor are arranged in most cases at an end part of a track frame of the crawler type traveling apparatus and the hydraulic motor is connected to a hydraulic source of a vehicle main body through hydraulic piping arrangements to constitute a compact crawler type traveling apparatus.

In the vehicles in which traction is of importance such as in a bulldozer, the crawler type traveling apparatuses are arranged in some cases on both right and left sides of the vehicle in such a fashion as to be capable of rocking up and down through respective pivot shafts as is well known in the art. In consequence, the right and left crawler type traveling apparatuses reliably catch the ground even on the ground having three-dimensional undulation, thereby giving large traction.

As a result, a crawler type traveling apparatus that is compact in size and has large traction can be accomplished when crawler type traveling apparatuses are arranged on both right and left sides of a vehicle through respective pivot shafts in such a fashion as to be capable of rocking up and down and a final reduction gear inclusive of a sprocket and a hydraulic motor are arranged at an end part of a track frame of each crawler type traveling apparatus.

In this case, however, the problem yet remains unsolved in that piping arrangements having a predetermined length and high flexibility such as hydraulic hoses are necessary as means for connecting the hydraulic motor arranged on the track frame that rocks up and down to the hydraulic source of the vehicle main body. In this case, the piping arrangements are likely to come into contact with sand and rocks and are likely to be damaged.

As an example of means for solving the problem, the following non-patent reference 1 illustrates a construction in which a hydraulic motor and a final reduction gear are arranged on a track frame rocking up and down, and a construction in which hydraulic piping arrangements for connecting the hydraulic motor and a hydraulic source of a vehicle main body are compactly constituted and are protected from sand and rocks.

Non-Patent Reference 1:

LIEBHERR Co. (LIEBHERR-EXPORT A.G.) PR712 Type, Operation and Maintenance Manual PR712, Litronic, Germany, P. O. Box 54, CH-5415, Nussbaumen, Manual No. IRM-710-06, P. 2-6

As a referential example for similarly solving the problem described above, the following patent reference 1 describes a construction in which hydraulic piping arrangements for connecting a hydraulic cylinder arranged on a track frame rocking up and down to a hydraulic source of a vehicle main body are inserted into hollow pivot shafts and are protected from sand and rocks.

Patent Reference 1:

Japanese Utility Model Laid-Open No. 113585/1990 (pages 3 to 5, FIG. 1)

An example of the crawler type traveling apparatus according to the related art will be explained on the basis of the example illustrated in the non-patent reference 1 described above with reference to FIGS. 5 and 6 of the accompanying drawings.

FIG. 5 is a side view of a bulldozer to which the crawler type traveling apparatuses according to the related art are applied, and FIG. 6 is an exploded sectional perspective view of the crawler type traveling apparatus and is a view as viewed from Q in FIG. 5.

Referring initially to FIG. 5, the bulldozer 61 has at its center a main frame 62 elongated in a longitudinal direction. Right and left crawler type traveling apparatuses 70, 70 are fitted to respective pivot shafts 63, that are provided to the main frame 62 on its right and left sides so as to protrude from the main frame 62, in the manner that they can oscillate around the pivot shaft axis P2. Each crawler type traveling apparatus 70 includes a track frame 71 elongated in the longitudinal direction, an idler 6 arranged at the front end part of the track frame 71, a predetermined number of track rollers 7 disposed on the lower surface of the track frame 71, a predetermined number of carrier rollers 8 disposed on the upper surface, a sprocket 81 disposed at the rear end part, and a belt 9 so fitted as to wind the idler 6, the track rollers 7, the carrier rollers 8 and the sprocket 81.

Next, in FIG. 6, a boss portion 71a arranged at a rear end part of the track frame 71 is rotatably inserted into the pivot shaft 63 fastened by a bolt to a left side plate 62a of the main frame 62 so that the track frame 71 can rock up and down. A final reduction gear 80 inclusive of a sprocket 81 is fitted to a vehicle inner side surface of a bracket portion 71b at the rear end part of the track frame 71. A hydraulic motor 90 is fitted to a vehicle outer side surface of the final reduction gear 80.

In FIG. 6, a predetermined number of hydraulic passages 91b, 92b, 93b and 94b are formed at an axial center portion of the pivot shaft 63 in such a fashion as to extend from the outer end face of the pivot shaft 63 towards its inner end face. A gallery block 95 is mounted to the outer end face. Hydraulic hoses 91a and 92a connected to a suction port and a discharge port, not shown, of the hydraulic motor 90 are communicated with a discharge port and a suction port of an hydraulic pump, disposed inside the main frame 62 and not shown, through the gallery block 95 and through the hydraulic passages 91b and 92b, respectively.

Similarly, a hydraulic hose 93a connected to a speed control port, not shown, of the hydraulic motor 90 and a hydraulic hose 94a connected to a brake release port of a parking brake, not shown, inside the reduction gear 80 are communicated with an operation valve, disposed inside the main frame 62 and not shown, through the gallery block 95 and through the hydraulic passages 93b and 94b, respectively.

A cover 96 is fitted so as to protect the gallery block 95 and the hydraulic hoses 91a, 92a, 93a and 94a.

In the construction shown in FIGS. 5 and 6, the hydraulic motor 90 is first arranged outside the vehicle at the bracket portion 71b at the rear end of the track frame 71. On the other hand, required ports of hydraulic appliances such as a hydraulic pump (not shown) inside the main frame 62 are communicated with the gallery block 95 fitted to the outer end face of the pivot shaft 63 through the hydraulic passages 91b 92b, 93b and 94b inside the pivot shaft 63 so that hydraulic hoses 91a, 92a, 93a and 94a having a small length can connect the hydraulic motor 90 and the gallery block 95 in a compact manner. As a result, the crawler type traveling apparatus 70 can achieve a compact piping arrangement construction.

However, the construction of the crawler type traveling apparatus according to the related art shown in FIGS. 5 and 6 involves the following problems because the hydraulic motor 90 is disposed on the more outer side of the vehicle than the final reduction gear 80 inclusive of the sprocket 81.
(1) The outer side surface of the crawler type traveling apparatus 70 often come into touch with obstacles such as surrounding grounds and pavement when the vehicle moves back and forth and turns and also impinges in many cases against rolling rocks from a mucking mound of sediment and/or rolling rocks from a wall of a bench-cut. For this reason, the possibility is large that the hydraulic motor 90 arranged close to the outer side surface of the crawler type traveling apparatus 70 and the hydraulic hoses 91c, 92c, 93c and 94c connected to the hydraulic motor 90 are damaged. As a result, the crawler type traveling apparatus 70 has low reliability.
(2) The depth of each hydraulic passage 91b, 92b, 93b, 94b formed in the pivot shaft 63 must be great so as to reach the inside of the side plate 62a of the main frame 62 from the outer end face of the pivot shaft 63. Therefore, a specific machine tool such as a gun drill and an extended machining time are necessary for forming each hydraulic passage 91b, 92b, 93b, 94b, and the crawler type traveling apparatus 70 has an expensive piping construction.

### SUMMARY OF THE INVENTION

In view of the problems described above, the invention aims at providing a crawler type traveling apparatus having a compact size, a low cost piping construction and high reliability in a crawler type traveling apparatus so arranged on each side of a vehicle as to be capable of rocking up and down through each pivot shaft, and including a track frame rocking round the pivot shaft and a final reduction gear inclusive of a sprocket and an hydraulic motor that are provided at an end part of the track frame.

To accomplish this object, a first invention of this application provides a crawler type traveling apparatus so arranged on each side of a vehicle as to be capable of rocking up and down through each pivot shaft and including a track frame rocking round the pivot shaft, and a final reduction gear inclusive of a sprocket and an hydraulic motor that are provided at an end part of the track frame, wherein the hydraulic motor is fitted on a vehicle inner side relative to the final reduction gear.

According to the first invention, the strong final reduction gear is arranged on the outer surface side of the crawler type traveling apparatus, and the hydraulic motor and piping arrangements connected to the hydraulic motor are arranged on the inner side of the final reduction gear. Therefore, when the crawler type traveling apparatus operates, the hydraulic motor and the piping arrangements connected to the hydraulic motor do not come into contact with the surrounding ground and pavement explained with reference to FIG. 6 (that explains the related art technology) and do not either impinge against rolling rocks from the mucking mound and/or from the wall of the bench-cut. Accordingly, the crawler type traveling apparatus has high reliability.

In the first invention described above, the second invention provides a construction in which hydraulic passages communicating with the hydraulic motor, etc, are defined in the pivot shaft.

In addition to the operation and effect of the first invention, the second invention provides the effect that the piping arrangements extending from the hydraulic appliances such as the hydraulic pump disposed inside the vehicle to the hydraulic motor and the like of the crawler type traveling apparatus can be arranged near the hydraulic motor without being exposed to the outside, and the piping construction that is compact and has high reliability can be acquired.

In the crawler type traveling apparatus according to the second invention, the third invention provides a construction in which a predetermined number of hydraulic piping arrangements connected to the hydraulic motor, etc are defined on an outer peripheral surface of the pivot shaft.

In addition to the operation and effect of the second invention, the third invention provides the following operation and effect.
(1) The piping arrangements such as the hydraulic hoses are extended from an arbitrary outer peripheral surface of each pivot shaft protruding in the transverse direction in front of the hydraulic motor to the hydraulic motor. In consequence, the hydraulic passages inside the pivot shaft can be connected to the hydraulic motor, etc and an extremely compact piping construction can be obtained.
(2) The length of each hydraulic passage formed inside the pivot shaft need not be the length that reaches the outer end face of the pivot shaft, and can be drastically reduced. Therefore, the hydraulic passages to be formed inside the pivot shaft can be easily machined by ordinary drilling, or the like, and an economical piping construction can be obtained.

As a result, in a crawler type traveling apparatus so arranged on each side of a vehicle as to be capable of rocking up and down through each pivot shaft and including a track frame rocking round the pivot shaft, and a final reduction gear inclusive of a sprocket and a hydraulic motor that are provided at an end part of the track frame, the invention can provide a crawler type traveling apparatus that has a compact size, a low cost piping construction and high reliability.

### BRIEF DESCRIPTION OF THE DRAWINGS

FIG. 1 is a side view of a bulldozer to which crawler type traveling apparatuses according to the invention are applied;

FIG. 2 is a top view of principal portions of the crawler type traveling apparatus according to the invention and is a sectional view taken along a line L-L of FIG. 1;

FIG. 3 is a perspective view of a pivot shaft and is useful for explaining hydraulic passages;

FIG. 4 is a side view of principal inner portions of the crawler type traveling apparatus according to the invention and is a sectional view taken along a line M-M in FIG. 2;

FIG. 5 is a side view of a bulldozer to which crawler type traveling apparatuses according to the prior art are applied; and

FIG. 6 is a sectional perspective view of principal portions of the crawler type traveling apparatus according to the related art and is a view from Q in FIG. 5.

### DESCRIPTION OF THE PREFERRED EMBODIMENT

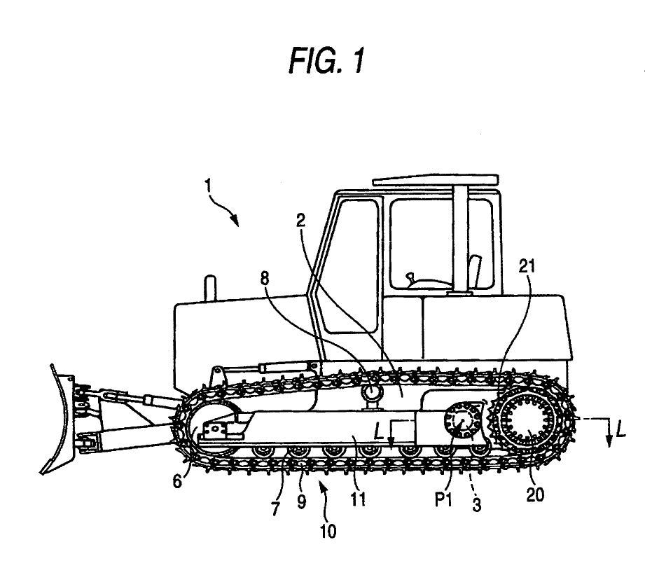

A crawler type traveling apparatus according to the invention will be hereinafter explained in detail about a bulldozer by way of example with reference to FIGS. 1 to 4.

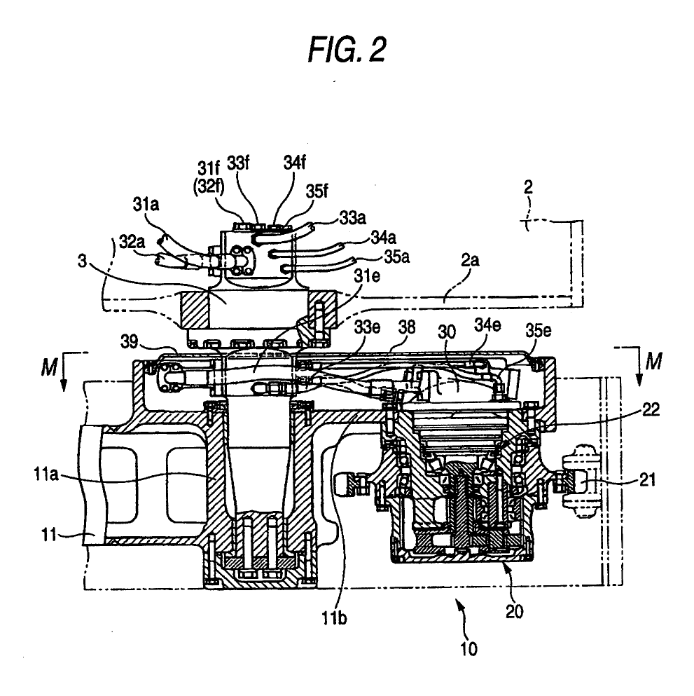

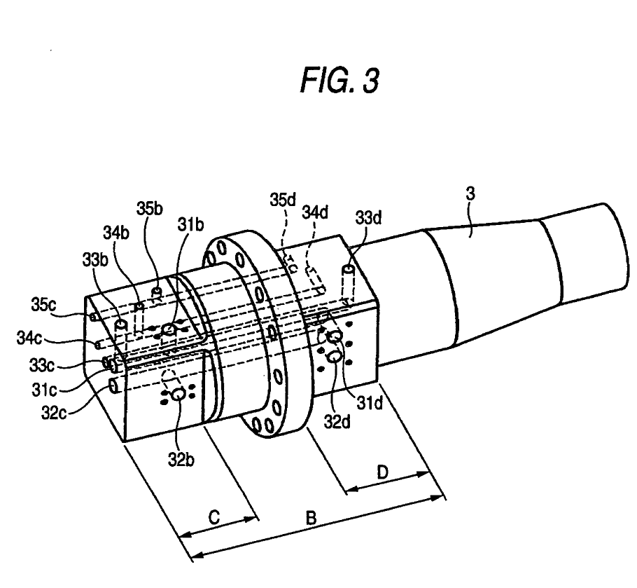

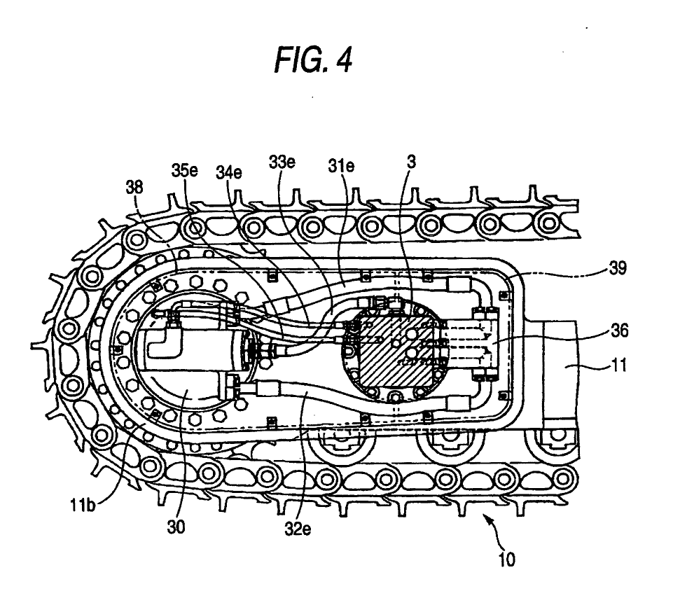

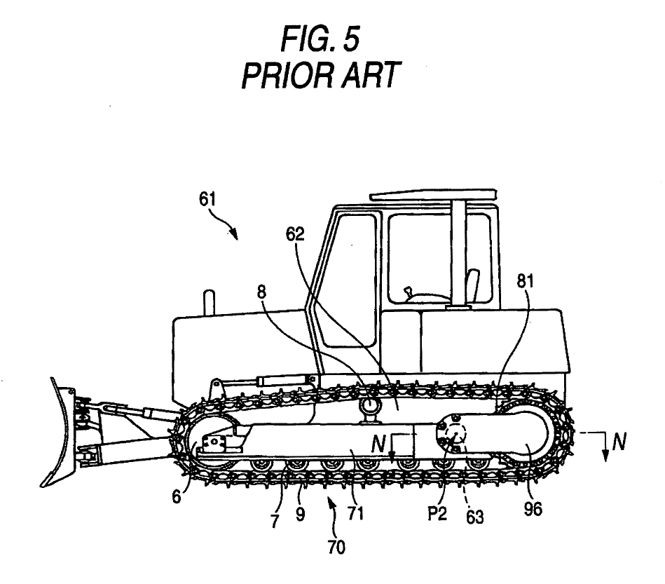

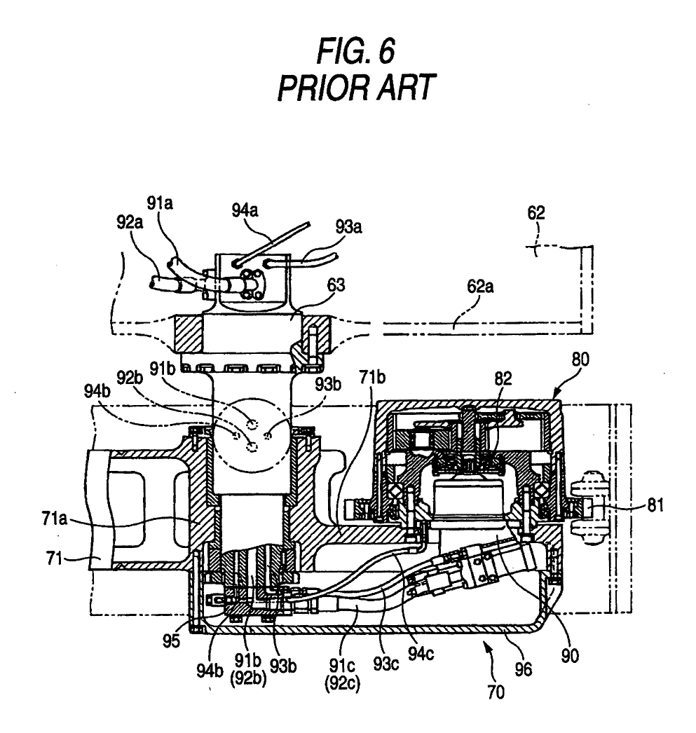

FIG. 1 is a side view of the bulldozer to which the crawler type traveling apparatuses according to the invention are applied. FIG. 2 is a top view of principal portions of the crawler type traveling apparatus and is a sectional view taken along a line L-L in FIG. 1. FIG. 3 is a perspective view of a pivot shaft and is useful for explaining hydraulic passages. FIG. 4 is a side view of principal inner portions of the crawler type traveling apparatus according to the invention and is a sectional view taken along a line M-M in FIG. 2. Incidentally, like reference numerals as those used in FIGS. 5 and 6 will be used to identify like constituent elements and explanation of such constituent elements will be omitted.

Referring initially to FIG. 1, the bulldozer 1 has at its center a main frame 2 that is elongated in a longitudinal direction. Pivot shafts 3 are fixed to the main frame 2 in such as fashion as to protrude from the main frame 2 on both right and left sides. Right and left crawler type traveling apparatuses 10 and 10 are fitted to the right and left pivot shafts 3, respectively, in such a fashion as to be capable of rocking at respective track frames 11 and 11 round the axes P1 of the pivot shafts 3. Incidentally, explanation will be hereinafter given on only the crawler type traveling apparatus 10 on the left side, and explanation on the crawler type traveling apparatus 10 on the right side will be omitted because it has the same construction as the crawler type traveling apparatus 10 on the left side.

Next, in FIG. 2, a boss portion 11a arranged at the rear part of the track frame 11 is rotatably fitted into the pivot shaft 3 protruding from a left side plate 2a of the main frame 2 and the track frame 11 can rock up and down. A final reduction gear 20 including a sprocket 21 is fitted to a vehicle outer side surface of a bracket portion 11b at the rear end of the track frame 11, and a hydraulic motor 30 is fixed to a vehicle inner side surface of the final reduction gear 20.

Referring next to FIG. 3, hydraulic passages 31c, 32c, 33c, 34c and 35c are so formed in the pivot shaft 3 as to extend from the inner end face of the pivot shaft 3 in the axial direction. Ports 31b, 32b, 33b, 34b and 35b for fitting piping arrangements (hereinafter merely called “inner ports”), respectively communicating with these hydraulic passages 31c, 32c, 33c, 34c, and 35c are formed in an outer peripheral surface of the pivot shaft 3 within a range C protruding to the inside of the main frame left side wall 2a. Similarly, ports 31d, 32d, 33d, 34d and 35d for fitting piping arrangements (hereinafter merely called “outer ports”), respectively communicating with the hydraulic passages 31c, 32c, 33c, 34c and 35c are formed within a range D protruding to the outside of the main frame left side wall 2a.

An inner end face opening of each of the hydraulic passages 31c, 32c, 33c, 34c and 35c is sealed through a plug 31f, 32f, 33f, 34f and 35f shown in FIG. 2.

Referring to FIGS. 2 to 4, piping arrangements 31a and 32a to be connected to a discharge side and a suction side of the hydraulic pump, not shown, a drain piping arrangement 33a to be connected to an operation oil tank, not shown, and piping arrangements 34a and 35a to be connected to an operation valve, not shown, are coupled with inner ports 31b, 32b, 33b, 34b and 35b of the pivot shaft 3, respectively, inside the left side plate 2a of the main frame 2.

Outside the left side plate 2a of the main frame 2, hydraulic hoses 31e and 32e are coupled with the outer ports 31d and 32d of the pivot shaft 3 through a gallery block 36, respectively. The hydraulic hoses 31e and 32e are connected at their other end with a suction port and a discharge port, not shown, of the hydraulic motor 30, respectively. Similarly, hydraulic hoses 33e, 34e and 35e are coupled with the outer ports 33d, 34d and 35 of the pivot shaft 3, respectively. These hydraulic hoses 33e, 34e and 35e are connected at their other end with a drain port and a speed control port, not shown, and a brake release port of a parking brake 22 of the final reduction gear 20, respectively.

Further, covers 38 and 39 are so adapted as to protect the hydraulic motor 30 and the hydraulic hoses 31e, 32e, 33e, 34e and 35e.

In the construction shown in FIGS. 1 to 4, the following operation and effect can be obtained.
(1) The hydraulic motor 30 is arranged the vehicle inner side with respect to the final reduction gear 20, and the strong final reduction gear 20 is arranged close to the outer side surface of the crawler type traveling apparatus 10. While the crawler type traveling apparatus operates, the hydraulic motor 30 arranged close to the inner side surface of the crawler type traveling apparatus 10 and the hydraulic hoses 31e, 32e, 33e, 34e and 35e coupled with the hydraulic motor 30 do not come into contact with the ground and the pavement described above with reference to FIG. 6 (that explains the related art technology) and are free from impingement with rolling stones from the mucking mound and/or from the wall surface of a bench cut.
(2) The hydraulic passages 31c, 32c, 33c, 34c and 35c communicating with the hydraulic motor 30, etc are defined inside the pivot shaft 3. Therefore, the piping arrangements that are so disposed as to extend from the hydraulic appliances arranged inside the left side plate 2a of the main frame such as the hydraulic pump towards the hydraulic motor 30 and the like of the crawler type traveling apparatus 10 can be arranged near to the hydraulic motor 30 without being exposed to the outside. Accordingly, the piping construction that is hardly damaged from the outside can be acquired.
(3) The ports 31d, 32d, 33d, 34d and 35d to be connected to a predetermined number of hydraulic piping arrangements coupled with the hydraulic motor 30 are formed in the outer peripheral surface of the pivot shaft 3. Therefore, an extremely compact piping construction can be obtained by connecting the hydraulic hoses 31e, 32e, 33e, 34e and 35e to the hydraulic motor 30 from an arbitrary outer peripheral surface of the pivot shaft 3 so arranged as to protrude to the right or left in front of the hydraulic motor 30.
(4) For the same reason as described in (3), the length of the hydraulic passages 31c, 32c, 33c, 34c and 35c to be arranged inside the pivot shaft 3 need not be the length extending to the outer end face of the pivot shaft 3 but may be within the range B shown in FIG. 3 and can be drastically reduced. Consequently, the hydraulic passages 31c, 32c, 33c, 34c and 35c can be easily machined by ordinary drilling and the like and an economical piping construction can be obtained eventually.

As described above, in a crawler type traveling apparatus so arranged on each side of a vehicle as to be capable of rocking up and down through each pivot shaft and including a track frame rocking round the pivot shaft and a final reduction gear inclusive of a sprocket and a hydraulic motor that are arranged at an end part of the track frame, the invention can provide a crawler type traveling apparatus having a compact and economical piping arrangement and achieving high reliability.

The crawler type traveling apparatus according to the invention has thus been explained about the crawler type traveling apparatus of the bulldozer by way of example, but the crawler type traveling apparatus according to the invention is not limited to the bulldozer but can be versatilely applied to crawler type traveling apparatuses of other machines in the same way and can obtain similar operation and effects.

1. A crawler type traveling apparatus so arranged on each side of a vehicle as to be capable of rocking up and down through each pivot shaft, comprising:
a track frame rocking around said pivot shaft; and
a final reduction gear inclusive of a sprocket and a hydraulic motor that are provided at an end part of said track frame,
wherein said hydraulic motor is arranged against said final reduction gear close to the inside of said vehicle.

2. The crawler type traveling apparatus according to claim 1, further comprising hydraulic passages inside said pivot shaft to communicate with said hydraulic motor.

3. The crawler type traveling apparatus according to claim 2, further comprising ports on an outer peripheral surface of said pivot shaft for respectively connecting a required number of hydraulic piping arrangements to said hydraulic motor.

4. A crawler traveling apparatus arranged on each side of a vehicle and rocking up and down through a pivot shaft, comprising:
a track frame rocking around said pivot shaft; and
a final reduction gear including a sprocket and a hydraulic motor arranged at an end of said track frame, said hydraulic motor being arranged against said final reduction gear and on an inner side of said vehicle relative to said final reduction gear.

5. The crawler type traveling apparatus according to claim 4, further comprising hydraulic passages arranged in a middle portion of said pivot shaft for communicating with said hydraulic motor.

6. The crawler type traveling apparatus according to claim 4, further comprising hydraulic passages arranged in a middle periphery portion of said pivot shaft for communicating with said hydraulic motor.

7. The crawler type traveling apparatus according to claim 5, further comprising piping connecting said hydraulic passages of said pivot shaft and said hydraulic motor, said connecting pipes being arranged on said inner side of said vehicle relative to said final reduction gear.

8. The crawler type traveling apparatus according to claim 6, further comprising piping connecting said hydraulic passages of said pivot shaft and said hydraulic motor, said connecting pipes being arranged on said inner side of said vehicle relative to said final reduction gear.
